(19) United States
(12) Patent Application Publication
(10) Pub. No.: US 2001/0019257 A1
(43) Pub. Date: Sep. 6, 2001

(54) Battery charging controller and conditioning system for lead acid batteries

(76) Inventors: Randy Bynum, San Jose, CA (US); Song W. So, San Mateo, CA (US)

Correspondence Address: Randy Bynum, 3634 Deedham Dr., San Jose, CA, 95148-3111, US

(21) Appl. No.: 09/760,365

(22) Filed: Jan. 12, 2001

Related U.S. Application Data
(62) Division of application No. 09/498,584, filed on Feb. 4, 2000, now abandoned.

(51) Int. Cl. H02J 7/04

(52) U.S. Cl. 320/141

(57) ABSTRACT

The current invention is a device for improving the charging process for all lead acid batteries. It also provides superior maintenance and conditioning of all lead acid batteries used in fossil fuel powered automobiles, any marine application, trucks, forklifts, telecommunications, aircraft, uninterruptible power supplies (UPS), golf carts, electric cars and many other similar applications. The current invention, by means of generating a high frequency pulse of sufficient amplitude and repetition rate, fed through a set of leads of sufficient size, removes lead plate sulfate deposits that plague virtually all lead acid batteries. By removing said deposits maximum available battery power is obtained. There is also a subsequent increase in battery life. The current invention uses an all solid state design.

### BACKGROUND

1. Field of Invention

This invention relates to battery maintenance and charging, specifically to lead acid batteries, in such a manner as to inhibit accumulation of and/or removal of sulfate deposits from the lead plates used in all lead acid batteries.

2. Discription of Prior Art

This invention relates to all lead acid battery applications, the battery chargers used on them, and the conditioning and ongoing maintenance of a lead acid battery to maintain maximum available power and the longest possible battery life while providing a high level of environmental protection due to fewer lead acid batteries being scrapped each year.

As part of the chemical process of converting chemical energy into electrical energy the lead acid battery is constantly cycled through both the charge and discharge process. During use, sulfates (SO₄) form an insulating layer by bonding to the lead electrodes. As sulfur is removed from the acid, water (H₂O) forms and causes a weakening of the sulfuric acid thereby lowering the Specific Gravity (SG) of the acid. Over time, these deposits constantly grow layer over layer on the electrode surfaces. The deeper the battery is discharged the greater the level of sulfate accumulation. The “standard” charging process tends to remove some of the sulfate deposits, but not all. This is true regardless of whether a low current charge or a high current charge is used. Over long periods of time the accumulation reaches a point which causes the battery to no longer be able to conduct sufficient current to meet the demand. As a result the battery fails. The vast majority of batteries scrapped are because of sulfate accumulation.

As these deposits cover more and more of the electrode surface they also become thicker. With time, particularly when a battery sits unused for long periods, the sulfate deposits begin to harden and the process of crystallization begins. This crystallized layer can cause two different battery failure modes; inability to conduct sufficient current due to the insulating film, or the crystallized deposits will fracture causing pieces to break off. These said crystallized pieces in turn will generally remove small pieces of the lead electrodes. As the pieces of crystallized sulfate and lead accumulate between electrodes they can cause one or more cells of the battery to short circuit rendering the battery useless.

Many different methods have been tried in an attempt to reduce or eliminate these normal and expected results. Each of these methods has met with limited success. We believe that prior inventors attempted to use existing designs from other technologies and adapt them to the process of charging and conditioning lead acid batteries. This is demonstrated by the fact that most prior art inventions use an old technology with a flyback transformer. During development of the current invention we set out to design a product that was simple, efficient and cost effective and did not rely on the flyback transformer.

There have been a several attempts to address sulfation. One such attempt is a pulsed voltage signal from a solar cell assembly as in U.S. Pat. No. 5,592,068 issued to Gregory et al. and entitled “Lead acid battery rejuvenator and U.S. Pat. No. 5,084,664 issued to Gali and entitled “Solar Powered Lead Acid Battery Rejuvenator and Trickle Charger”. These techniques utilize a flyback transformer which decreases system efficiency and increases internal pulse charger temperatures while adding to the cost and complexity of the device.

Other techniques have been employed such as in U.S. Pat. No. 5,710,506 issued to Broell et. al. entitled “Lead acid charger” which uses a technique to switch between current regulation or voltage regulation mode which increases the amount of required circuitry thereby raising unit cost, weight, complexity, and the potential for unit malfunction. Even though it attempted to solve the sulfate problem by employing two different charging methods our tests show this technique to be inferior to the current invention. The Broell method also allows the battery to control the process, not the pulse charger meaning that the condition of the battery is able to set the sulfate removal conditions which we consider less then optimal.

Another attempt at improving lead acid battery charging was covered in U.S. Pat. No. 5,525,892 issued to Phommarath entitled “Pulsed battery rejuvenator having variable trailing edge shaped pulses.” This technique is believed to have offered significant benefit to lead acid battery charging by eliminating the transformer. However, the circuitry required for this process is considerably more complicated then that required for the current invention. In addition, there is no documented study found that has shown that the variable trailing edge shaped pulses provides any assurance of complete sulfate removal in lead acid battery charging. This prior art technique also allows for the battery to control the charging process. We believe the technique to be less effective then the current invention. During current invention development it was found that the best results were obtained by allowing said invention to control the charging process and not allow the condition of the battery being charged to control it.

### SUMMARY

In accordance with the current invention, the pulse charging device provides an optimized method of charging lead acid batteries to reduce sulfate build up, extended battery life, and reduces the overall environmental impacts of lead acid battery disposal. The current invention also overcomes numerous drawbacks of all known prior art devices; fewer components, lighter weight, higher efficiency and lower cost. The said current invention utilizes a technique that remains in control of the battery charging process assuring proper sulfate removal as opposed to the battery condition controlling the process which results in reduced sulfate removal.

The current invention uses three basic components; an oscillator, voltage adjust, and pulse driver circuits. In order to guard against damage from potential reverse polarity a dual failsafe protection device is built in. The pulse signal is a narrow band signal producing a voltage appropriate for type of lead acid battery being charged, maintained or rejuvenated. The small Pulse Charger, for up to 150 amp hour lead acid batteries, operates at a frequency between 6 and 12 kilohertz (KHz) while the heavy duty Pulse Charger operates in a frequency range of between 7 KHZ and 16 KHz. The said pulse signal of the current invention utilizes a fairly fast raise time with a slightly slower decay time at a relatively fixed time interval as specified previously. There are different models available to cover virtually all lead acid batteries regardless of the voltage or rated power as defined by a ampere/hour rating. These models include, but are not limited to, the standard battery sizes of 6, 12 and 24 volt (up to 150 amp hour) and 6, 12, 24, 36, 48, 72 and 84 volt batteries of up to 1500 amp hours.

The design of the present invention is such that a minimum number of components have been used while providing an output pulse that is virtually unaffected by battery condition or the source of the charging voltage. This provides for both optimum battery charging and battery maintenance. The current invention works with all charging voltage sources including but not limited to alternators, generators, switching and transformer based DC power supplies which all supply a voltage appropriate for the said lead acid battery being charged and maintained. It is generally left connected across the battery terminals at all times.

### OBJECTS AND ADVANTAGES

Accordingly, several objects and advantages of our invention are:

a) a self contained system that uses the preexisting charging voltages from any of several sources to both charge a lead acid battery as well as condition said battery.

b) no need to switch between different modes of charging since the current invention is fully automatic.

c) the current invention provides a pulse signal to the electrodes of a lead acid battery using an appropriate rise time, decay time and repetition rate in order to provide maximum battery charging and conditioning effect. Since these pulses are distributed across all electrodes, the battery is fully protected, charged and conditioned.

d) the device is left permanently connected to the battery so as to provide the maximum amount of protection, power, and longevity.

e) positive environmental effects are achieved by reducing lead acid battery failures resulting in fewer battery disposals.

Accordingly, it is therefore the object of this invention to solve the pre-existing problems with standard charging systems and at the same time overcome limitations of existing “pulse charger” techniques at a cost low enough that the average user can and will likely use the technology.

Further, a principal object of this invention is to prevent battery overheating, lead plate damage and the hardening of lead acid batteries from sulfation. This is accomplished by maintaining Specific Gravity (SG) of the lead acid battery at as high a level as possible.

Further, a principal object of this invention is to provide a reduction in environmental impacts of failed battery recycling by prolonging battery life. This also would reduce the amount of sulfuric acid and lead recycling from used batteries.

Further, a principal object of this invention is to extend the useful life and usability of lead acid batteries as long as possible through improved automatic (no user action required) maintenance and charging of lead acid batteries.

Further, a principal object of this invention is to provide a method of achieving the above benefits while providing protection against draining of battery power over time. The said invention turns itself off following removal of the charging voltage.

Further, a principal object of this invention is to provide a relatively narrow frequency range of pulses that are not dependant upon battery condition. This method allows an opportunity to have a faster and more positive impact on said battery. The current invention allows itself to control the charging of the battery and does not to allow the battery to control the charging process.

Further, a principal object of this invention is to provide a product that will do all of the above listed things regardless of the charging voltage source. It will work with an AC powered charger, an on board engine driven alternator or generator or any other power source of sufficient voltage to charge the battery.

Further, a principal object of this invention is to use a 100% solid state circuit that operates at a very high level of efficiency.

Further a principal object of this invention is to provide for application to all 6, 12, 24,36, 48, 72 and 84 volt batteries. Both light duty (150 amp/hour) and heavy duty (>150 amp hour) batteries are treated with the appropriate product.

Features of this invention include: an automated charge optimization system, a high frequency pulse signal to remove existing sulfate deposits and to prevent new deposit formation thereby avoiding the common crystallization of said deposits. The current invention will also turn itself off when no charging voltage exists so as to not drain the battery.

### DRAWING FIGURES

FIG. 1 is a schematic drawing of the Pulse Charger circuitry.

FIG. 2 is a schematic diagram of a sample charging system, a lead acid battery and the current invention connected together.

Reference Numerals In Drawings

| | |
|---|---|
| 12) | Oscillator circuit |
| 24) | Voltage adjust circuit |
| 36) | Pulse driver circuit |
| 39) | Reverse voltage protection device |
| 48) | Pulse Charger Connected to a battery and a charging voltage source |

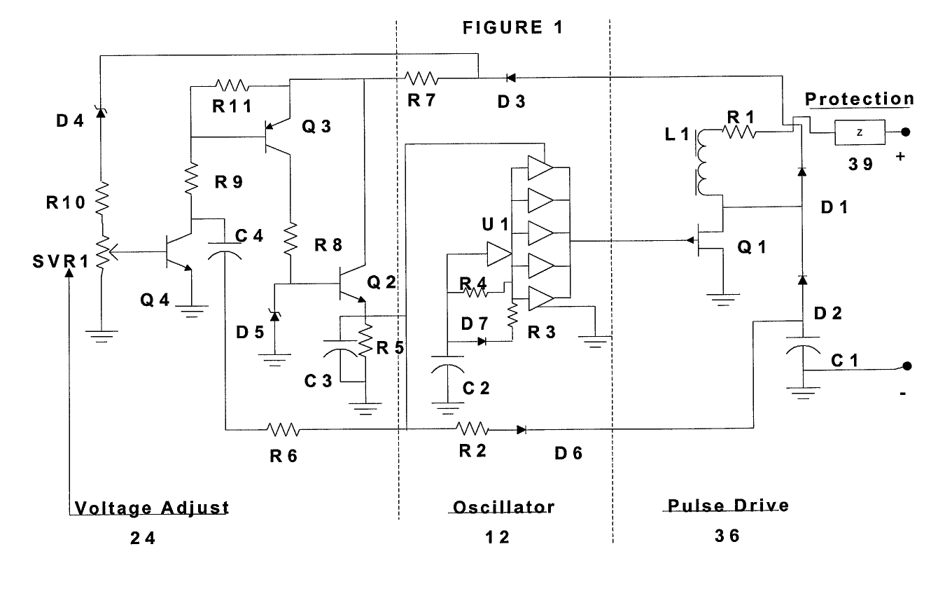

Description, FIG. 1

Operation of the current invention is very simple. There are three primary circuits of the current invention; the voltage adjust circuit, the oscillator and the output pulse driver circuit. We will describe each portion of the circuit independently.

The voltage adjust circuit 12 determines the operating voltage level of the current invention. The voltage adjust circuit is connected directly to the battery supply voltage through diode D3 and resistor R7. The output signal of transistor Q4 is determined by the ratio of voltage applied to its base through zener diode D4, resistor R10 and potentiometer SVR1. Zener diode D4 provides a stable reference voltage for the circuit. Transistor Q4 in turn drives transistor Q3 through a voltage ratio determined by the collector current of transistor Q4 through resistors R9 and R11. Transistor Q3 is biased by zener diode D5 and resistor R8 which also sets the base voltage for transistor Q2. Resistor R5 sets the bias level of transistor Q2. Transistor Q2 is also interconnected to the multivibrator oscillator circuit with a common feedback path through resistor R2 and diode D2 and D6 back to the output of transistor Q1.

The oscillator circuit 24 is a inexpensive and very reliable multivibrator that provides the final drive transistor Q1 with the proper pulse width modulation drive signal. The oscillator is powered through the voltage adjust circuit just described. The oscillator output frequency and polarity is determined by the combination resistors R3 and R4, Diode D9 and capacitor C2.

The pulse driver circuit 36 consists of transistor Q1, inductor L1 and resistor R1. Diode D1 provides a low resistance path to the said lead acid battery terminals for the output pulse from the final drive transistor. The protection circuit 39, which is in series with the incoming voltage feed from the said lead acid battery, provides a means of protecting the current invention from inadvertent voltage reversal during user installation. Should reverse voltage be applied to the current invention during user installation, no current will flow into the current invention nor will reverse polarity voltages reach the voltage polarity sensitive solid state devices used in the said current invention. However, the current invention will also not function if left connected with reversed operating voltage. The said protection device 39 provides two levels of protection since it a combination poly switch and diode.

Advantages

From the description above, a number of advantages of our Pulse Charger become evident:

A) A pulse frequency of a predetermined bandwidth optimized for the individual type of battery

B) High overall system efficiency

C) Reduced internal temperatures

D) Elimination of the traditional flyback transformer

E) Controls the charging process and will not allow battery condition to control the process

F) Suppression of spurious emissions for RFI/EMI control

G) Ultra low noise output pulse

H) Will not drain a battery if left connected for long periods of time without a charger

J) Dual protection from potential reverse voltage user installation damage

K) Low end user purchase cost

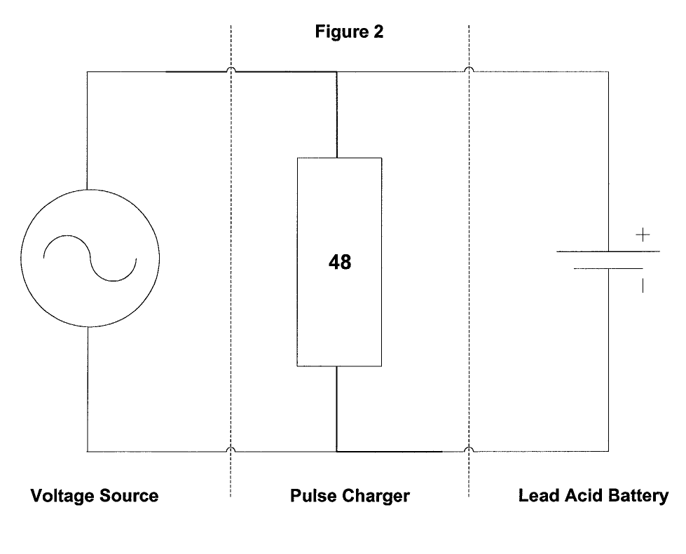

Operation—FIG. 2

Operation of the current invention is very straight forward even though implementation has been done in a very unique manner. Great effort has been undertaken to make the product as simple and inexpensive as possible yet reliable and effective. In order to provide the user with adequate benefits and features, an internally (factory) preset solid state voltage adjustment circuit controls the output signal of the oscillator circuit. The said oscillator in turn drives the pulse driver which creates the final output pulse signal. The input of the current invention is also protected against reverse voltage polarity damage by a poly switch and a diode. This two level protection approach is considered far superior to standard diode only protection.

There is no user input required during or after installation in order to ensure proper operation of the current invention.

The output pulse is delivered to the battery via color coded wires (red for positive and black for negative) of sufficient size as to not impede or attenuate pulse signals prior to their reaching the battery terminals.

Conclusion, Ramifications and Scope

Accordingly, the reader will see that the current invention provides efficient state-of-the-art lead acid battery charging and protection in a fully automatic mode. By using a series of pulses falling in the 6 to 16 KHZ frequency range optimum results are obtained using a minimum number of components. The all solid state design is highly efficient resulting in lower internal power losses and cooler operating temperatures. By virtue of the design, potential EMI/RFI issues have been greatly reduced. The Pulse Charger will turn itself off once the charging voltage has been removed eliminating battery drain. To protect the product from possible reverse polarity voltage an internal solid state protection device is included in the design. The end result benefits the user by prolonging battery life with a higher SG. There are environment benefits as well since there will be fewer lead acid batteries requiring recycling. All this at a very low cost making widespread product distribution likely.

We claim:

1. When battery charging with a pulse charger signal there is an optimum way of regulating and responding to changes in battery condition and controlling the said process in order to obtain the maximum benefit to a lead acid battery without causing RFI/EMI problems.
a. further provides for a stable narrow bandwidth pulse
b. further provides means for maintaining control of and/or regulating overall charging process
c. further allows operation at a preset frequency that changes only slightly based on battery condition
d. further provides pulse current at amplitude 2 to 3 times battery voltage
e. further conducts said current through a low an impedance conductor to the battery
f. further minimizes spurious emissions
g. further provides low noise pulse signal to battery

2. In order to provide proper pulse charging and maximum available battery power the said pulse charger does not consume power when the charging voltage source is turned off
a. further automatically detects the presence of the charging voltage enabling operation
b. further automatically detects loss of charging voltage disabling operation
c. further includes internal reverse polarity protection to protect itself and battery

3. The current invention is designed as all solid state
a. further employs solid state electronic switching
b. further includes a means of switching the FET powered pulse on and off
c. further includes a solid state multivibrator circuit as pulse driver
d. further includes a zener diode stabilized base voltage
